(19) United States
(12) Patent Application Publication
(10) Pub. No.: US 2010/0122713 A1
(43) Pub. Date: May 20, 2010

(54) WASHING METHOD AND APPARATUS FOR USE THEREIN

(76) Inventors: Tadaharu Tanaka, Osaka (JP); Shogo Araki, Osaka (JP); Naoki Yanai, Osaka (JP); Motonobu Shiomi, Osaka (JP); Yoshitaka Senzaki, Osaka (JP); Masataka Oshima, Aichi (JP)

Correspondence Address: BIRCH STEWART KOLASCH & BIRCH, PO BOX 747, FALLS CHURCH, VA, 22040-0747, US

(21) Appl. No.: 12/598,257

(22) PCT Filed: Nov. 8, 2007
(86) PCT No.: PCT/JP2007/071707

§ 371 Date: Oct. 30, 2009

(30) Foreign Application Priority Data
May 10, 2007 (JP) 2007-125888

(51) Int. Cl. B08B 3/00

(52) U.S. Cl. 134/26; 134/198

(57) ABSTRACT

A method of washing an object to be processed, using water containing at least either one selected from a hydrogen radical and a carbon radical, and a novel method capable of exerting sufficient washing effect without using chemicals, by a washing apparatus having a processing bath for washing an object to be processed, and a means for supplying the processing bath with water containing at least either one selected from a hydrogen radical and a carbon radical, and an apparatus for the novel method are provided.

### TECHNICAL FIELD

The present invention relates to a washing method using water containing a hydrogen radical and/or a carbon radical, and to an apparatus for use in the washing method.

### BACKGROUND ART

Recently in Japan, as increasing of imported foods, the problem of safety due to residual post harvest agricultural chemicals used for vegetables and fruits has been focused. In domestic farm goods, a problem of safety due to residual pre harvest agricultural chemicals used in culture has also been focused although the residue is known to be quantitatively smaller than that of post harvest agricultural chemicals. On the other hand, farm goods cultured without agricultural chemicals or produced by organic farming have increased year after year. These farm goods are not necessarily safe because harmful bacteria can be adhered, although residual agricultural chemicals are small.

Therefore, it is important to sufficiently wash the farm goods for securing safety and sanitation of foods.

Conventionally, washing and sterilization have been conducted using chemicals, however, from the concern about the influence on a human body, various methods in which foods are washed and sterilized sufficiently in such a manner that a human body is not influenced have been proposed recently. As one exemplary method, a washing method using a hydroxyl radical is proposed. A hydroxyl radical is generated, for example, by a method of irradiating ozone water with ultraviolet.

However, since a hydroxyl radical has a short life time (10⁻⁶M⁻¹S⁻¹), even if water containing a hydroxyl radical is produced, and the water is taken out of the system and allowed to act on an object to be processed, a sufficient effect is difficult to be obtained. Therefore, it is necessary to conduct ultraviolet radiation in a condition that ozone water and an object to be processed are in contact with each other, or it is necessary to utilize a hydroxyl radical generating method using chemicals. However, if ultraviolet radiation is conducted in a condition that ozone water and an object to be processed are in contact with each other, deterioration of the object by the ozone water and/or gas leakage into the operation environment can occur, and problems arise that ultraviolet fails to transmit due to debris in an aqueous solution, that a hydroxyl radical generates only on the irradiated face, and the like. On the other hand, in utilizing a hydroxyl radical generating method using chemicals, a post washing may be necessary or use of chemicals themselves is sometimes avoided.

For example, Japanese Patent Laying-Open No. 2001-231525 (Patent document 1) discloses a method of conducting sterilization more efficiently by making an aqueous solution containing a hydroxyl radical into collision with an object to be processed at high speed in a shower mode. However, there still remains a problem of short life time of a hydroxyl radical as described above.

For example, Japanese Patent Laying-Open No. 2005-237230 (Patent document 2) discloses a method of reducing ozone consumption by organic substances released from foods by separately providing an ozone water washing water bath, an ozone water sterilization water bath, and an ozone water freshness keeping water bath. However, the method disclosed in Patent document 2 has a drawback that the apparatus is bulky because of requirement of two-step or three-step process.

Patent document 1: Japanese Patent Laying-Open No. 2001-231525
Patent document 2: Japanese Patent Laying-Open No. 2005-237230
Patent document 3: Japanese Patent Laying-Open No. 2005-185144

### DISCLOSURE OF THE INVENTION

### Problems to be Solved by the Invention

The present invention was made to solve the above problems, and it is an object of the present invention to provide a novel method capable of exerting sufficient washing effect without using chemicals, and an apparatus for the method.

### Means for Solving the Problems

The present invention provides a method of washing an object to be processed using water containing at least either one selected from a hydrogen radical and a carbon radical.

Preferably, the water containing at least either one selected from a hydrogen radical and a carbon radical used in the method of the present invention exhibits decrease from 800 mV to 200 mV of oxidation-reduction potential at a decreasing rate of 100 mV/second or less.

Preferably, the water containing at least either one selected from a hydrogen radical and a carbon radical used in the method of the present invention is produced by causing generation of a hydroxyl radical in water containing a water-soluble organic substance, or by causing generation of a hydroxyl radical in water mixed with gas containing at least either one selected from a hydrogen atom and a carbon atom.

Preferably, in the method of the present invention, the water containing at least either one selected from a hydrogen radical and a carbon radical is brought into contact with an object to be processed in a dipping mode or in a shower mode. Among these, it is more preferred to bring the water containing at least either one selected from a hydrogen radical and a carbon radical into contact with an object to be processed in a shower mode. In this case, an object to be processed may be washed by supplying water containing at least either one selected from a hydrogen radical and a carbon radical in a shower mode from above a processing bath so that water containing at least either one selected from a hydrogen radical and a carbon radical is pooled in the processing bath in such an amount that the object to be processed can be dipped in a condition that the water containing at least either one selected from a hydrogen radical and a carbon radical after process is discharged from the bottom of the processing bath.

The present invention also provides a washing apparatus including a processing bath for washing an object to be processed, and a means for supplying the processing bath with water containing at least either one selected from a hydrogen radical and a carbon radical.

In the apparatus of the present invention, it is preferred that the means for supplying the water containing at least either one selected from a hydrogen radical and a carbon radical has a means for supplying water containing a water-soluble organic substance and a means for causing generation of a hydroxyl radical in the water containing a water-soluble organic substance, or has a means for mixing gas containing at least either one selected from a hydrogen atom and a carbon atom into water, and a means for causing generation of a hydroxyl radical in water mixed with the gas.

Preferably, the apparatus of the present invention includes a shower head having a means for supplying water containing a water-soluble organic substance or water mixed with gas containing at least either one selected from a hydrogen atom and a carbon atom and generating the hydroxyl radical in the water, wherein water containing at least either one selected from a hydrogen radical and a carbon radical is supplied to the processing bath via the shower head in a shower mode.

Preferably, the apparatus of the present invention includes a processing bath configured so as to discharge water containing at least either one selected from a hydrogen radical and a carbon radical after process in the bottom, and a means for supplying water containing at least either one selected from a hydrogen radical and a carbon radical in a shower mode via a shower head from above the processing bath, wherein the means for supplying water containing at least either one selected from a hydrogen radical and a carbon radical preferably has a configuration to supply water containing at least either one selected from a hydrogen radical and a carbon radical into the processing bath so that water containing at least either one selected from a hydrogen radical and a carbon radical is pooled in the processing bath in such an amount that an object to be processed can be dipped in a condition that the water containing at least either one selected from a hydrogen radical and a carbon radical after process is discharged from the bottom of the processing bath.

Preferably, in the apparatus of the present invention, the processing bath is formed into mesh in its bottom only.

Preferably, in the apparatus of the present invention, the processing hath has a pump, for discharging water containing at least either one selected from a hydrogen radical and a carbon radical after process in its bottom.

Preferably, the apparatus of the present invention is able to keep water level of water containing at least either one selected from a hydrogen radical and a carbon radical in the processing bath constant.

Preferably, in the apparatus of the present invention, the processing bath is able to oscillate. Preferably, the apparatus of the present invention also has a means for supplying bubbling air provided in the bottom of the processing bath.

### EFFECTS OF THE INVENTION

According to the present invention, by using a radical generating in a chain reaction originally from a hydroxyl radical, sufficient washing effect is exerted on an object to be processed. Since the water containing at least either one selected from a hydrogen radical and a carbon radical used in the present invention can exert sufficient effect even when it is acted on an object to be processed in a shower mode, it is possible to constantly supply fresh water containing at least either one selected from a hydrogen radical and a carbon radical, and to obtain a uniform and high washing effect. Further, the present invention is advantageous in that adverse affect on a processing environment and an object to be processed is small because washing is achieved by chemical action of a radical.

### BRIEF DESCRIPTION OF THE DRAWINGS

FIG. 1 is a view showing an ESR chart of one example of radical water preferably used in a bacteria removing or particle removing method of the present invention.

FIG. 2 is a view schematically showing a washing apparatus 1 that is one preferred embodiment of the present invention.

FIG. 3 is a view schematically showing a washing apparatus 21 that is another preferred embodiment of the present invention.

FIG. 4 is an enlarged perspective view of a part of apparatus 21 shown in FIG. 3.

FIG. 5 is a view schematically showing a washing apparatus 41 that is another preferred embodiment of the present invention.

FIG. 6 is a graph showing a result of Experimental Example 1.

FIG. 7 is a graph showing a result of Experimental Example 3.

FIG. 8 is a graph showing a result of Experimental Example 7.

FIG. 9 is a graph showing a result for a dipping mode of Experimental Example 8.

FIG. 10 is a graph showing a result for a shower mode of Experimental Example 8.

FIG. 11 is a graph showing a result of Experimental Example 11.

FIG. 12 is a graph showing a result of Experimental Example 1.

### DESCRIPTION OF THE REFERENCE SIGNS

1, 21, 41 washing apparatus, 2, 22 processing bath, 3 conduit, 4 tank, 5 chemical feeding device, 6 concentration meter, 7 ozone generator, 8 mixing pump, 9 reaction tower, 9a ultraviolet lamp, 10 conduit, 11 concentration meter, 12 conduit, 13 conduit, 14 shower head, 15 radical water, 16 oxidation-reduction potentiometer, 17 conduit, 18 conduit, 19 concentration meter, 23 bucket, 24 shower head, 25 radical water, 26 bucket bottom face, 27 radical water, 28 pump, 29 conduit, 30 ultraviolet lamp, 31 conduit, 32 bubbling air supply path, 33 valve, 42 ultrasonic sensor, 43 electrode sensor, 44 control means

### BEST MODES FOR CARRYING OUT THE INVENTION

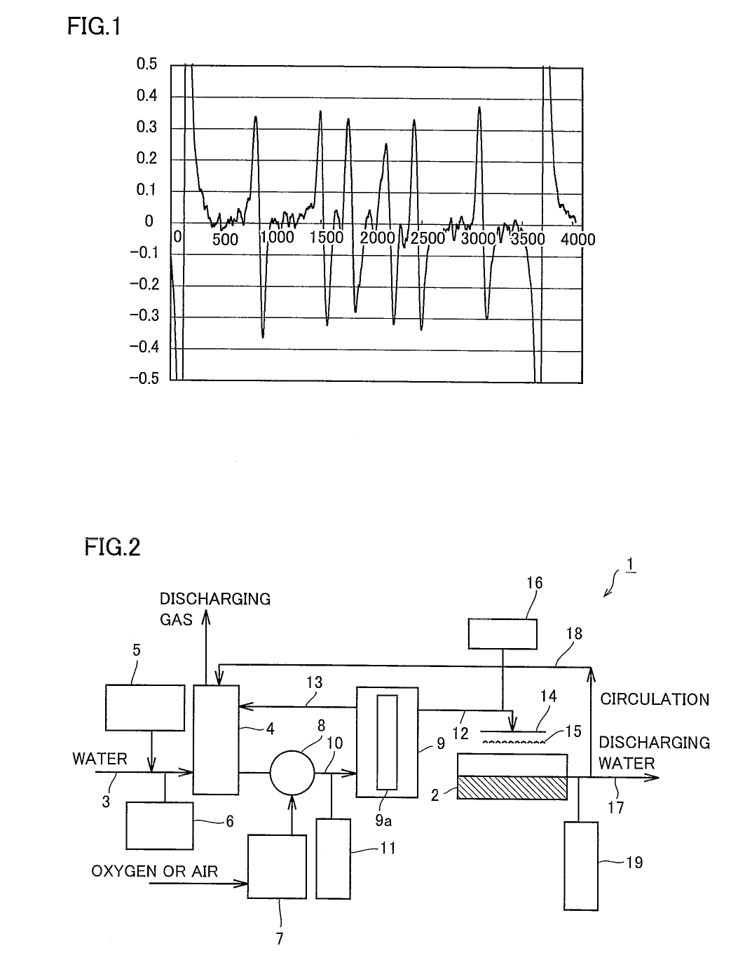

The present invention provides a method of washing an object to be processed by removal of bacteria or particles using water containing a hydrogen radical (H.) and/or a carbon radical (R.) (hereinafter, referred to as “radical water”). The radical water used in the present invention may only contain at least either one of a hydrogen radical and a carbon radical. Preferably, the radical water in the present invention is water containing both a hydrogen radical and a carbon radical. Inclusion of a hydrogen radical and/or a carbon radical in water can be confirmed by subjecting the water to electron spin resonance (ESR) (also called as Electron Paramagnetic Resonance) using a free radical monitor JES-FR30 (manufactured by JEOL Ltd.) and examining whether there is a peak that indicates existence of a hydrogen radical, or a carbon radical from the obtained ESR chart. FIG. 1 shows an ESR chart for one example of radical water (radical water using tap water obtained in Experimental Example 2 as will be described later) used in the method of the present invention. The term “a carbon radical” used herein refers to an organic compound wherein carbon or a carbon atom moiety of carbon compound becomes a radical.

The term “washing” used herein can exert an effect of removing bacteria or particles in addition to an effect of a so called washing (these effects are collectively called as “washing effect”). Here, “removing bacteria” means removing bacteria from an object to be processed. “Removing particles” means removing particles such as contaminants and debris from an object to be processed. It is natural that washing by the present invention encompass removing of agricultural chemicals remaining in a object to be processed such as vegetables from the object to be processed.

In the method of the present invention, the object to be processed is not particularly limited and it is suitably applied particularly for washing of objects to be processed containing abundant organic substances, such as cut vegetables, hen eggs, seafood, food producing machines, medical devices, linens, semiconductors, and electronic parts. It may also be suitably applied to objects to be processed made of materials such as metals, polymer compounds (in particular, a fluorine resin or a silicone compound having low hydrophilicity (hydrophobic)) and the like.

In the radical water used in the present invention, since a hydrogen radical or a carbon radical is sequentially generated by a chain reaction, the bacteria removing or particle removing effect is exerted for a long time compared to a hydroxyl radical (OH.) of which life time is 10⁻⁶M⁻¹S⁻¹. Such radical water in the present invention acts to neutralize electric charges of adhered particles or bacteria to remove them or make them less likely to adhere again because it has an electric property different from that of unprocessed water (for example, tap water) although it lacks such a strong oxidizing power and a sterilizing power as that of water containing a hydroxyl radical. Therefore, the radical water in the present invention is able to exert the bacteria removing or particle removing effect as described above without influencing on an object to be processed, and this effect is kept for a practical time level even when the generated radical water is taken out of the system for use. Therefore, such radical water is advantageous in that it can keep the effect even when it is applied to a shower mode exhibiting higher washing effect than a dipping mode as will be described later. Furthermore, since the radical water used in the present invention does not contain ozone, a washing process by removing of bacteria or particles can be conducted without exerting adverse affect on a processing environment and an object to be processed.

In the method of the present invention, it is preferred that the radical water exhibits decrease of oxidation-reduction potential from 800 mV to 200 mV at a decreasing rate of 100 mV/second or less. This is because when radical water exhibiting a decreasing rate of oxidation-reduction potential of more than 100 mV/second is used, content of a hydrogen radical or a carbon radical appears to be low and the washing effect tends to be low. More preferably, the decreasing rate of oxidation-reduction potential is 10 mV/second or less because more excellent washing effect is realized.

The decreasing rate of oxidation-reduction potential of radical water is measured using an apparatus having the same configuration as the washing apparatus of the present invention of the example shown in FIG. 2 as will be described later except that in a reaction tower, radical water generated immediately after ultraviolet radiation by a ultraviolet lamp is supplied into water containing a water-soluble organic substance (containing a hydroxyl radical) mixed with ozone in a 100 mL-volume beaker into which an ORP electrode of a portable ORP meter RM-20P (manufactured by DKK-TOA Corporation) is inserted. First, radical water immediately after ultraviolet radiation is supplied to overflow into the 140 mL-volume beaker into which an ORP electrode is inserted at a flow rate of 5 liters/minutes, the beaker is taken out of the system of the apparatus, and supply of radical water to the beaker is stopped. Then from an ORP value immediately after taking the beaker out of the system, and an ORP value after 10 seconds, measured by the portable ORP meter RM-20P, a decreasing rate of oxidation-reduction potential per one second is calculated.

The radical water used in the method of the present invention may be produced in any method as far as it is produced to contain at least either one of a hydrogen radical and a carbon radical. As one preferred method of producing the radical water, a method involving causing generation of a hydroxyl radical (OH.) in water containing a water-soluble organic substance, and causing generation of a hydrogen radical and a carbon radical by a chain reaction with a water-soluble organic substance originally from the a hydroxyl radical is exemplified. That is, this is a method in which a hydroxyl radical is caused to generate by a so-called advanced oxidation process, and the a hydroxyl radical is not directly used for the process, but a carbon radical and a hydrogen radical are caused to generate in a chain reaction originally from the a hydroxyl radical, and water containing the secondarily generated a carbon radical and/or a hydrogen radical (radical water in the present invention) is produced.

As the “water-soluble organic substance” used herein, known designated food additives and existing food additives may be preferably used, and for example, alcohols such as methanol, ethanol and isopropanol, acetone, hydrogen peroxide, and ethyl acetate can be recited. The “water containing a water-soluble organic substance” used herein also encompasses tap water (TOC<5 mg/h).

As a method of advanced oxidation process for causing generation of a hydroxyl radical in water containing a water-soluble organic substance as described above, for example, an ozone/ultraviolet combined method that itself is known in the art is recited. As a hydroxyl radical generating pathway in the ozone/ultraviolet combined method, for example, such a pathway is assumed in which an OH radical is generated via HO₂ radical as ozone reacts with water in the processing liquid to autolyze in the following manner.

O₃+H₂O→HO₃⁺+OH⁻

HO₃⁺+OH⁻→2HO₂.

O₃+2HO₂.→OH.+2O₂

As a hydroxyl radical generating pathway in the ozone/ultraviolet combined method, such a pathway is also assumed in which an OH radical is generated via hydrogen peroxide by irradiating ozone with ultraviolet.

O₃+H₂O+hν→H₂O₂+O₂

H₂O₂+hν→2OH.

The hydroxyl radical generated in such a pathway reacts with a water-soluble organic substance (R) in water in the following manner and a radical reaction starts in such a manner that hydrogen is drawn out from the water-soluble organic substance.

RH+OH.→R.+H₂O

Further, a generated a carbon radical R. reacts with other water-soluble organic substance (R′) in water, and a carbon radical or a hydrogen radical is generated in a chain reaction in the following manner.

R.+R′H→RH+R′.

R.+R′H→RR′+H.

When water containing a hydrogen radical and/or a carbon radical is produced by causing generation of a hydroxyl radical in water containing a water-soluble organic substance, a preferred concentration of the water-soluble organic substance in water varies depending on a kind of the water-soluble organic substance, and an object to be processed by the radical water, and is not particularly limited, however, TOC (total organic carbon) is preferably within a range of 0.01 to 20 mg/L, and more preferably within a range of 0.1 to 10 mg/L.

The radical water in the present invention may be such that a hydrogen radical and a carbon radical are caused to generate by mixing gas containing a hydrogen atom and/or a carbon atom such as hydrogen gas or carbon dioxide gas into water (preferably, tap water, pure water or ultrapure water) and causing generation of a hydroxyl radical in the water into which the gas is mixed. Water in which a hydrogen radical or a carbon radical is caused to generate by such dissolved gas in ultrapure water is also encompassed in the radical water in the present invention.

When the radical water in the present invention is produced by mixing gas containing a hydrogen atom and/or a carbon atom with water, and causing generation of a hydroxyl radical in the water, preferred concentration of gas containing a hydrogen atom and/or a carbon atom in water varies depending on a kind of gas, and the object to be processed by the radical water and is not particularly limited, however, it is preferably within a range of 1 to 50 ppm, and more preferably within a range of 1 to 20 ppm.

In the washing method of the present invention using the radical water, a method of bringing the radical water into contact with an object to be processed is not particularly limited, however, the contact is preferably achieved in a dipping mode or a shower mode. Among these, it is preferred to bring radical water in the present invention into contact with an object to be processed in a shower mode capable of conducting efficient washing in a short time while its washing effect is less likely to be inhibited even when the object to be processed is cut vegetable from which a liquid (leaching liquid) is leached such as cabbage cut into strips. The radical water in the present invention is able to exert the washing effect satisfactorily even when it is taken out of the system for generating the radical water after generation and brought into contact with an object to be processed in a dipping mode or in a shower mode because sequential radical generation is continued by the chain reaction as described above, and it may be preferably applied particularly in a shower mode.

In the washing method of the present invention, when the shower mode is applied, it is particularly preferred to wash an object to be processed by supplying radical water in a shower mode from above a processing bath so that the radical water is pooled in the processing bath in such an amount that the object to be processed is dipped, in a condition that the radical water after process is discharged from the bottom of the processing bath.

FIG. 2 is a view schematically showing a washing apparatus 1 that is one preferred embodiment of the present invention based on bacteria removal or particle removal. Apparatus 1 of the present invention basically has a processing bath 2 for washing an object to be processed by bacteria removal or particle removal, and a means for supplying processing bath 2 with the radical water (water containing a hydrogen radical and/or a carbon radical). In apparatus 1 having such a basic configuration, with introducing an object to be processed into processing bath 2 and bringing it into contact with radical water, it is possible to conduct the washing method of the present invention based on bacteria removal or particle removal.

In the apparatus of the present invention, the means for supplying radical water preferably has a means for supplying water containing a water-soluble organic substance and a means for causing generation of a hydroxyl radical in the water containing a water-soluble organic substance. By further having these means, the radical water in the present invention can be preferably produced by, as described above, causing a hydroxyl radical to generate in water containing a water-soluble organic substance, and causing a hydrogen radical and a carbon radical to generate in water by a chain reaction with a water-soluble organic substance originally from the a hydroxyl radical. In the apparatus of the present invention, the means for supplying radical water may have a means for mixing gas containing a hydrogen atom and/or a carbon atom (for example, hydrogen gas or carbon dioxide gas) into water, in place of the means for supplying water containing a water-soluble organic substance, and even with such a configuration, the radical water containing a hydrogen radical and/or a carbon radical in the present invention can be preferably produced.

When the means for supplying radical water has a means for supplying water containing a water-soluble organic substance and a means for causing generation of a hydroxyl radical in the water containing a water-soluble organic substance, the means for supplying water containing a water-soluble organic substance is preferably implemented to have, as is the example shown in FIG. 2, a conduit 3 for supplying raw water, a tank 4 for reserving the water containing a water-soluble organic substance supplied via conduit 3, and a chemical feeding device 5 connected in the middle of conduit 3, for adding a water-soluble organic substance to raw water as is necessary. In such apparatus 1, as the raw water supplied to conduit 3, pure water, ultrapure water, preliminarily prepared water containing a water-soluble organic substance (including tap water) and the like may be used. When preliminarily prepared water containing a water-soluble organic substance such as tap water is supplied, it may be supplied to tank 4 without being added with a water-soluble organic substance by chemical feeding device 5. As is the example shown in FIG. 2, a concentration meter 6 (for example, UV organic substance meter UVAS-sc (manufactured by Central Kagaku Corp.) or the like) for measuring concentration of water-soluble organic substance in water may be provided as is necessary, in the middle of conduit 3 (between the part connected with chemical feeding device 5 and tank 4). When the means for supplying radical water has a means for mixing gas containing a hydrogen atom and/or a carbon atom into water, it may be realized so that the required gas containing a hydrogen atom and/or a carbon atom is added to raw water supplied to conduit 3 by chemical feeding device 5 in the example shown in FIG. 2, for example. In this case, as the raw water, pure water or ultrapure water is preferably used.

In the example shown in FIG. 2, the means for causing generation of a hydroxyl radical is implemented to have an ozone generator 7 for causing generation of ozone from oxygen or air as a raw material, a mixing pump 8 for pumping up water containing a water-soluble organic substance or water mixed with gas containing a hydrogen atom and/or a carbon atom from tank 4, and mixing it with ozone generated in ozone generator 7, and a reaction tower 9 accommodating a ultraviolet lamp 9a for irradiating water (containing a hydroxyl radical) mixed in mixing pump 8 with ultraviolet. As mixing pump 8, it is preferred to use a mixing pump capable of blowing the ozone generated in ozone generator 7 in the form of micro-bubbled multiphase flow to be supersaturated with respect to water containing a water-soluble organic substance, or water mixed with gas containing a hydrogen atom and/or a carbon atom pumped up from tank 4. In this manner, the radical water in the present invention is produced by blowing ozone into the water containing a water-soluble organic substance, or into water mixed with gas containing a hydrogen atom and/or a carbon atom in excess of its solubility, and irradiating ultraviolet by ultraviolet lamp 9a inside reaction tower 9 to cause generation of abundant a hydroxyl radicals, and causing a hydrogen radical and a carbon radical to generate in water by a chain reaction with a water-soluble organic substance in the water as described above.

In apparatus 1 having the configuration as shown in FIG. 2, as ozone generator 7 and ultraviolet lamp 9a, a conventionally known ozone generator and ultraviolet lamp (for example, as the ozone generator, widely used water-cooling ozone generator ED-OG-G1 (manufactured by Ecodesign Inc.) or the like, as the ultraviolet lamp, low pressure mercury lamp SUV-40 (manufactured by SEN LIGHTS Co., Ltd.) or the like) may be used in appropriate combination without any particular limitation. As is the example shown in FIG. 2., apparatus 1 of the present invention may be provided with a concentration meter 11 (for example in-line type dissolved ozone monitor EL-600 (manufactured by EBARAJITSUGYO CO., LTD.) or the like) for measuring the concentration of ozone in the middle of a conduit 10 connecting mixing pump 8 and reaction tower 9.

As for the radical water after ultraviolet radiation by ultraviolet lamp 9a, a necessary amount that is at least a part thereof is supplied to processing bath 2 via a conduit 12, and the remainder is returned to tank 4 via a conduit 13. In the apparatus of the present invention, the radical water may be brought into contact with an object to be processed in processing bath 2 in any of dipping mode or shower mode. FIG. 2 shows an example of configuration in which a tip end of conduit 12 is connected with a shower head 14 so that the radical water is brought into contact with an object to be processed, and shower-like radical water 15 is poured into processing bath 2 via shower head 14. As shower head 14, a conventionally known appropriate shower head may be used without any particular limitation, however, it is desired to use a shower head capable of pouring the shower-like radical water over the entire object to be processed accommodated in processing bath 2. Apparatus 1 of the present invention may be provided with an oxidation-reduction potentiometer 16 (for example, industrial ORP meter HDM-138A (manufactured by DKK-TOA Corporation) or the like) in the middle of conduit 12 connecting reaction tower 9 and shower head 14 as is the example shown in FIG. 2.

Apparatus 1 of the present invention may be configured to circulate the radical water in processing bath 2 as is necessary. FIG. 2 shows an example in which the radical water in processing bath 2 is configured to be discharged through a conduit 17 as is necessary, and a conduit 18 is connected in the middle of conduit 17 for circulating part of the radical water discharged from processing bath 2 into tank 4. Preferably, when water containing a hydrogen radical and/or a carbon radical is produced by causing generation of a hydroxyl radical in water containing a water-soluble organic substance, as is the example shown in FIG. 2, apparatus 1 is configured such that a concentration meter 19 (for example, UV organic substance meter UVAS-sc (manufactured by CENTRAL KAGAKU CORP.) or the like) is provided in the middle of conduit 17 (between processing bath 2 and the part to which conduit 18 is connected), and the concentration of the water-soluble organic substance in the radical water after process is measured by concentration meter 19, and if the measurement is less than the concentration of the water-soluble organic substance measured by concentration meter 6 provided in the middle of conduit 3, the water is discharged, whereas if it is equal to or more than the concentration of the water-soluble organic substance measured by concentration meter 6, the water is circulated.

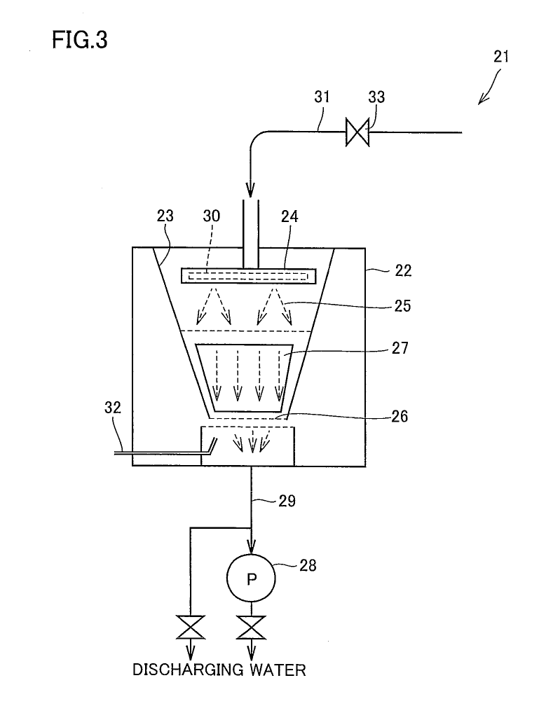

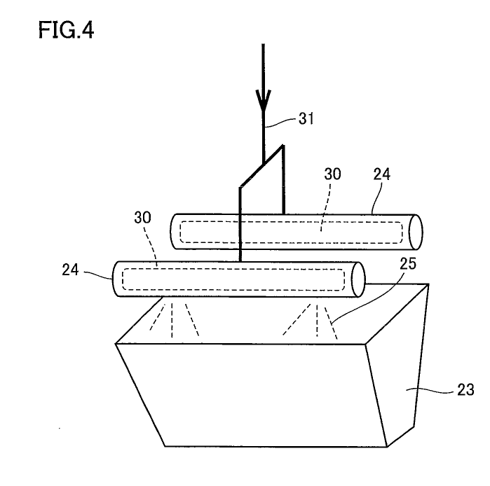

FIG. 3 is a view schematically showing a washing apparatus 21 that is another preferred embodiment of the present invention, and FIG. 4 is a perspective view showing a part thereof with enlargement. In apparatus 21 in the examples shown in FIG. 3 and FIG. 4, a configuration particularly preferred for a case where radical water is brought into contact with an object to be processed in a shower mode. In washing apparatus 21 of the present invention, as shown in FIG. 3, for example, a bucket 23 having an internal space capable of accommodating shower-like radical water 25 supplied through a shower head 24 is provided inside a processing bath 22, and bucket 23 and processing bath 22 are configured to be able to discharge the radical water after process from the bottoms. In processing bath 22 in washing apparatus 21 of the present invention, it is preferred to be configured that mesh is formed only a bottom face 26 of bucket 23, but mesh is not formed in lateral faces as shown in FIG. 3. As described above, by forming mesh only in bottom face 26, it is possible to prevent the washing effect of an object to be processed placed on the bottom face of the processing bath from decreasing because the radical water supplied through the shower head reaches the bottom face without being discharged from the lateral face, unlike a case of forming mesh in lateral face of the bucket. As is in the example shown in FIG. 3, bucket 23 is preferably realized to have an internal space formed so that an area with respect to the horizontal direction gradually decreases from top to bottom (for example, in the form of a mortal). By realizing bucket 23 to have an internal space of such a shape, an advantage arises such that radical water passes through the object to be processed.

The means for supplying radical water in washing apparatus 21 of the present invention is realized, for example, by connecting a conduit 31 for supplying radical water to shower head 24. To this conduit 31, for example, a means for supplying water containing a water-soluble organic substance and an ozone generator similarly to those of the apparatus of the example shown in FIG. 2 may be connected on the side opposite to the side where it is connected to shower head 24. Apparatus 21 of the example shown in FIG. 3 and FIG. 4 is configured such that a ultraviolet lamp 30 is incorporated in shower head 24, and for example, water containing a water-soluble organic substance mixed with ozone is supplied to shower head 24 through conduit 31. By ultraviolet lamp 30 in shower head 24, a hydroxyl radical further generates in water containing a water-soluble organic substance mixed with ozone supplied to shower head 24, so that an object to be processed can be subjected to the washing process based on bacteria removal or particle removal while the radical water in the present invention containing a hydrogen radical and/or a carbon radical originally from the a hydroxyl radical is constantly kept in fresh condition. In the middle of conduit 31, a valve 33 for controlling flow rate of supplied radical water may be provided as is the example shown in FIG. 3. As shower head 24 that may be used in washing apparatus 1 of the present invention, a conventionally known one may be used appropriately without any particular limitation.

In the present invention, it is preferred that the means for supplying radical water is configured to supply radical water into processing bath 22 so that the amount of radical water capable of dipping an object to be processed is pooled in processing bath 22 in a condition that radical water after process is discharged from the bottom of processing bath 22. As a result, the washing process using washing apparatus 21 of the present invention is conducted by dipping an object to be processed in radical water 25 pooled in an internal space of bucket 23, and supplying radical water 25 into processing bath 22 in a shower mode from above processing bath 22 in the means for supplying radical water. In this manner, since radical water 25 is supplied in a shower mode, influence by eluate from an object to be processed is small, and since it is possible to bring radical water into contact with the entire object to be processed as well as with the face of the object to be processed where the shower abuts by dipping the object to be processed in radical water in processing bath 22, uniform and high washing effect can be obtained. Therefore, washing effect is dramatically improved compared to conventional washing apparatuses that conduct washing in either of a shower mode or a dipping mode. The washing apparatus of the present invention eliminates the need of stirring in contrast to a washing apparatus conducting washing only in a dipping mode, so that sufficient washing effect can be exerted even when a smaller processing bath compared with a washing apparatus conducting washing only in a dipping mode is used, and higher water-saving effect is achieved.

Preferably, the processing bath in the washing apparatus of the present invention has a pump for discharging radical water after process in its bottom. FIG. 3 shows an example in which a conduit 29 is connected with the bottom of processing bath 22 via a pump 28, and radical water is sequentially discharged from a bottom face 26 by pumping out with pump 28 while a constant amount of radical water 27 is pooled in bucket 23. As a result, a downward stream from above arises in radical water 27 pooled in bucket 23, so that in addition to the above-described washing effect by dipping an object to be processed in radical water 27 pooled in the internal space of bucket 23 and supplying radical water 25 into processing bath 22 according to a shower mode by the means for supplying radical water, it is possible to bring radical water 27 into contact with the entire object to be processed by the stream. Hence, dramatically excellent washing effect can be obtained.

Preferably, the washing apparatus of the present invention is able to keep water level of radical water in the processing bath constant. As a result, it is possible to conduct efficient washing while pooling radical water in an amount such that an object to be processed can be dipped in the processing bath. For example, in the case of washing apparatus 21 in the example shown in FIG. 3, it is possible to keep the water level of radical water in processing bath 22 by manually adjusting a supply amount of radical water by valve 33 or a discharge amount of radical water by a discharge valve.

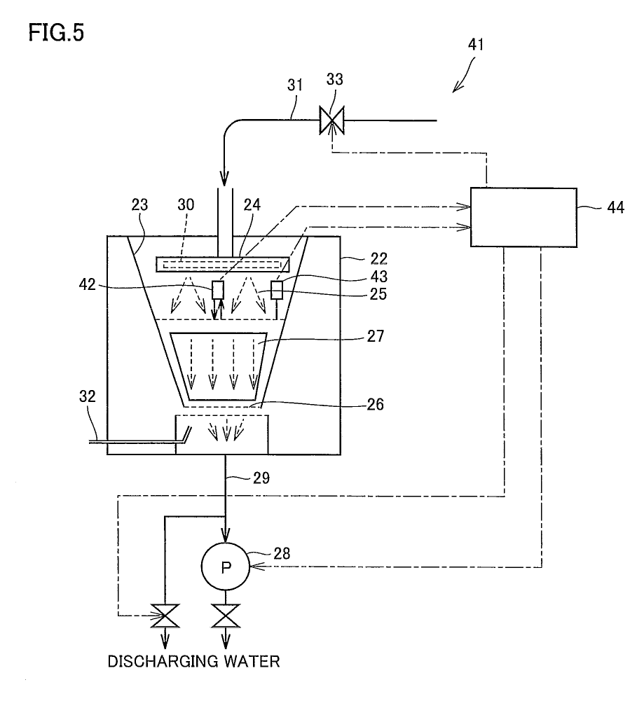

FIG. 5 is a view schematically showing a washing apparatus 41 of another preferred embodiment of the present invention. Washing apparatus 41 of the example shown in FIG. 5 is similar to washing apparatus 21 of the example shown in FIG. 3 except for a certain part, and the part having an identical configuration will be denoted by the same reference numeral, and description thereof will be omitted. Washing apparatus 41 of the example shown in FIG. 5 includes as a means for sensing liquid level of radical water 27 accommodated in processing bath 22, an ultrasonic sensor 42 and an electrode sensor 43. It may be naturally a configuration only including either one of ultrasonic sensor 42 and electrode sensor 43. In the example shown in FIG. 5, a control means 44 is provided that obtains information about liquid level of radical water obtained from ultrasonic sensor 42 and electrode sensor 43 (shown by dashed line in FIG. 5) and controls a supply amount and/or a discharge amount of the radical, water. Valve 33 provided in conduit 31 for supply of the radical water and/or the valve provided in conduit 29 for discharge of the radical water is implemented, for example, by an electromagnetic valve, and a flow rate of the radical water is controlled by control means 44 according to the above information. In this case, as is in the example shown in FIG. 5, when pump 28 is provided in conduit 29 for discharge of the radical water, it may be realized so that a discharge amount of radical water can be controlled by control (ON/OFF, revolution speed) of pump 28. According to such washing apparatus 41 of the example shown in FIG. 5, it is possible to automatically keep water level of radical water 27 accommodated in processing bath 22 constant. As ultrasonic sensor 42, electrode sensor 43, control means 44 and the electromagnetic valve in the example shown in FIG. 5, those conventionally known may be appropriately combined for use, without any particular limitation.

Preferably, the processing bath in the washing apparatus of the present invention is oscillatable, or provided with a means for supplying bubbling air in its bottom. Apparatus 21 of the example shown in FIG. 3 shows an example in which a bubbling air supply path 32 is provided for supplying air for bubbling from the bottom of bucket 23. By oscillating the processing bath or by supplying bubbling air during the washing process, the object to be processed in the processing bath is stirred, and the washing effect can be further improved. By oscillating the processing bath or by supplying bubbling air after subjecting the object to be processed to washing process for a certain time, the object to be processed is inverted in bucket 23, and then the object to be processed may also be subjected to washing process for another certain time. In this manner, it is possible to bring radical water into contact with the entire object to be processed more uniformly. In the present invention, the means for making the processing bath oscillatable or the means for supplying bubbling air can be realized by a person skilled in the art with combining conventionally known means appropriately without any limitation.

In the following, the present invention will be described more in detail by way of Experimental examples, however, the present invention will not be limited thereto.

### Experimental Example 1

An experiment for examining a relationship between the concentration of a water-soluble organic substance in water and the generated radical species was conducted using a quartz cell for absorbance measurement. As water subjected to generation of a radical, ultrapure water, 1% ethanol aqueous solution, 5% ethanol aqueous solution, 10% ethanol aqueous solution and 20% ethanol aqueous solution were respectively used, and after blowing ozone therein in an amount exceeding solubility, radical water was caused to generate by irradiation for 10 minutes by a ultraviolet lamp. Immediately after generation, each radical water was subjected to electron spin resonance (ESR) using a free radical monitor JES-FR30 (manufactured by JEOL Ltd.), and from the obtained ESR chart, radical species and content proportions in radical water were detected.

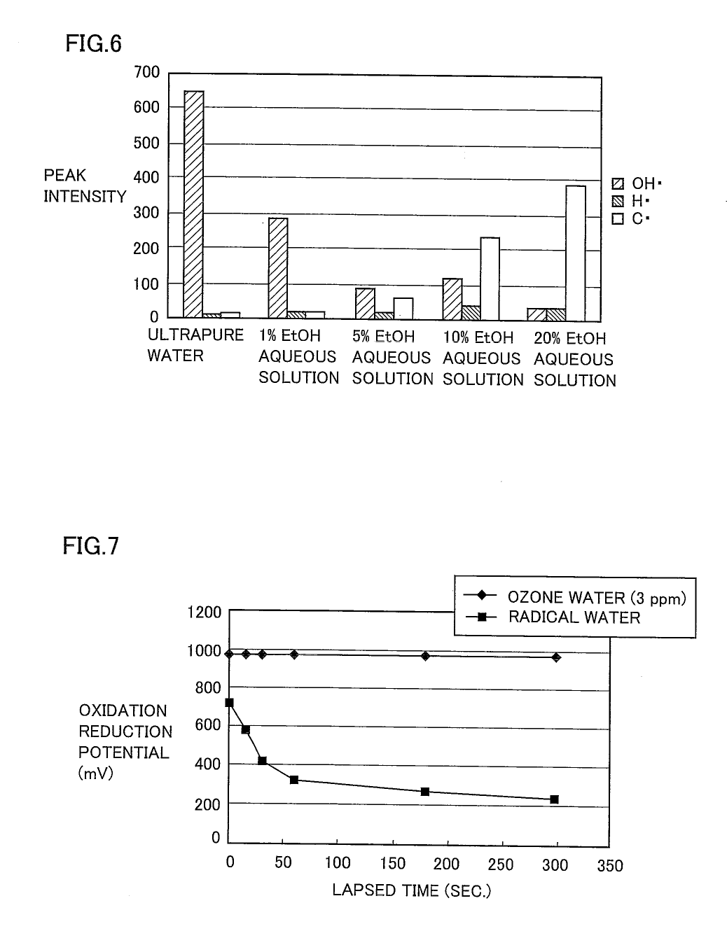

FIG. 6 is a graph showing results of Experimental Example 1. In FIG. 6, for radical water obtained by using ultrapure water, 1% ethanol aqueous solution, 5% ethanol aqueous solution, 10% ethanol aqueous solution and 20% ethanol aqueous solution, peak intensities of a hydroxyl radical(OH.), a hydrogen radical (H.) and a carbon radical (R.) in ESR are shown. From FIG. 6, it can be found that in the radical water using ultrapure water not containing water-soluble organic substance, only a hydroxyl radical is detected, and as the ethanol concentration increases, the generation rate of the hydroxyl radical decreases and proportions of a hydrogen radical and a carbon radical increase.

### Experimental Example 2

After blowing ozone of an amount exceeding solubility into tap water using the apparatus of the present invention shown in FIG. 2, radical water was caused to generate by conducting ultraviolet lamp radiation. Immediately after generation, the radical water was subjected to electron spin resonance (ESR) using a free radical monitor JES-FR30 (manufactured by JEOL Ltd.). FIG. 1 shows a ESR chart obtained in Experimental Example 2.

In the ESR chart of FIG. 1, a peak indicating existence of a hydrogen radical and a peak indicating existence of a carbon radical are observed, while on the other hand, a peak indicating existence of a hydroxyl radical is not observed. This suggests that the hydroxyl radical generated by ozone and ultraviolet radiation reacts with a water-soluble organic substance in water (organic substance contained in tap water, in this Experimental example) to generate a hydrogen radical and a carbon radical.

### Experimental Example 3

After blowing ozone of an amount exceeding solubility into tap water using the apparatus of the present invention shown in FIG. 2, radical water was caused to generate by conducting ultraviolet lamp radiation. For the radical water generated in this manner, a time-dependent change of oxidation-reduction potential (ORP) was measured using an industrial ORP meter HDM-138A (manufactured by DKK-TOA Corporation). As a comparative experiment, a time-dependent change of oxidation-reduction potential (ORP) was also measured for ozone water (3 ppm).

FIG. 7 is a graph showing a result of Experimental Example 3, where the vertical axis represents oxidation-reduction potential (mV) and the horizontal axis represents lapsed time (second). As shown in FIG. 7, the oxidation-reduction potential of radical water decreased to 324 mV after a lapse of about 1 minute from 725 mV observed immediately after generation. On the other hand, in the case of ozone water, oxidation-reduction potential was 975 mV even after a lapse of about 1 minute from immediately after measurement, and no change was observed.

### Experimental Example 4

An experiment for examining a relationship between oxidation-reduction potential of radical water and sterilization effect was conducted. 1 mL of bacterial liquid extracted with phosphate buffered saline from macrophyll was introduced into 100 mL of liquid medium (nutrient broth), and cultured at 37° C. for 24 hours under shaking, and 1 mL of this culture liquid and 100 mL of each sample solution were put into a sterilized bag, mixed by shaking well, and then viable cell counts were determined by a pour plate method, and thus sterilizing ability of each sample solution was examined. As sample solutions, radical waters at the points of time when oxidation-reduction potential was 700 mV, 600 mV, 450 mV, 350 mV, 300 mV and 250 mV, respectively after generating radical water by radiation of ultraviolet lamp after blowing ozone of an amount exceeding solubility into tap water using the apparatus of the present invention shown in FIG. 2, were used. As a comparative experiment, a similar experiment was conducted for sterilization ability when culture liquid (original liquid) alone, tap water, ozone water (3 ppm) and hypochlorous acid water (200 ppm) were respectively used as a sample solution. The result is shown in Table 1.

TABLE 1

| | Viable cell counts |
|---|---|
| Sample solution | (cells/g) |
| Culture liquid (original liquid) | 4.87E+07 |
| Tap water | 4.53E+05 |
| Ozone water (3 ppm) | 3.08E+03 |
| Hypochlorous acid aqueous solution (200 ppm) | 1.00E+00 |
| Radical water (ORP: 700 mV) | 1.80E+05 |
| Radical water (ORP: 600 mV) | 4.53E+05 |
| Radical water (ORP: 450 mV) | 4.25E+05 |
| Radical water (ORP: 350 mV) | 3.45E+05 |
| Radical water (ORP: 300 mV) | 3.78E+05 |
| Radical water (ORP: 250 mV) | 3.98E+05 |

From Table 1, it can be found that when tap water was used as a sample solution, the viable cell counts was about 1/100 of that when the culture liquid (original liquid) alone was used by dilution as a sample solution, and sterilizing effect was not observed. In the case of radical water, viable cell counts similar to that of tap water was observed irrespective of the value of oxidation-reduction potential, and this suggests that the radical water does not have sterilizing effect unlike the ozone water and hypochlorous acid water.

### Experimental Example 5

An experiment for examining a relationship between oxidation-reduction potential of radical water and washing effect was conducted. Using the apparatus shown in FIG. 2, about 5 g of macrophyll was put into a processing bath (5 L) and ozone of an amount exceeding solubility was blown into tap water, and then irradiation of ultraviolet lamp was conducted to generate radical water at 1 L/minute. Then radical waters at the points of time when oxidation-reduction potential was 450 mV, 300 mV, 270 mV, and 250 mV were supplied to the processing bath in a dipping mode, and the radical water was allowed to be in contact with macrophyll that is an object to be processed for about 5 minutes, and thereafter viable cell counts was calculated in a similar manner as in Experimental Example 4. Decreasing rate of oxidation-reduction potential of radical water was 5 mV/second. As a comparative experiment, viable cell counts was calculated in a similar manner for a case where washing was conducted in a similar manner with tap water or hypochlorous acid water (200 ppm) as well as a case where washing was not conducted. The result is shown in Table 2.

TABLE 2

| | Viable cell counts |
|---|---|
| Sample solution | (cells/g) |
| Unwashed | 4.3E+05 |
| Tap water | 6.1E+03 |
| Hypochlorous acid aqueous solution (200 ppm) | 1.4E+02 |
| Radical water (ORP: 450 mV) | 1.1E+02 |
| Radical water (ORP: 300 mV) | 1.8E+03 |
| Radical water (ORP: 270 mV) | 2.5E+03 |
| Radical water (ORP: 250 mV) | 2.2E+03 |

From Table 2, it was confirmed that the radical water having an oxidation-reduction potential of 450 mV or more exerted a washing ability substantially equal to that of hypochlorous acid.

### Experimental Example 6

Using the apparatus shown in FIG. 2, ozone of an amount exceeding solubility was blown into tap water, and then irradiation of ultraviolet lamp was conducted to generate radical water at 3 L/minute. Then at the point of time when oxidation-reduction potential immediately after generation was 600 to 700 mV, radical water was brought into contact with an object to be processed in the processing bath for 5 minutes in a shower mode so that the radical water was in contact with the object to be processed. As the object to be processed, Welsh onion (initial cell counts: 1.2×10⁵ cells/g), cucumber (initial cell counts: 6.1×10⁴ cells/g), carrot (initial cell counts: 1.4×10⁴ cells/g), lettuce (initial cell counts: 9.0×10⁴ cells/g), macrophyll (initial cell counts: 1.4×10⁷ cells/g) and radish (initial cell counts: 3.3×10³ cells/g) that are cut vegetables were respectively used, and about 5 g for macrophyll and about 25 g for objects to be processed other than macrophyll were put into a processing bath (5 L). Decreasing rate of oxidation-reduction potential of radical water was 5 mV/second. As a comparative experiment, 200 mg/L of a hypochlorous acid aqueous solution commonly used in vegetable sterilization was brought into contact with each object to be processed for 5 minutes in a shower mode. After this process, viable cell counts were calculated for each object to be processed in a similar manner as in Experimental Example 4. The result is shown in Table 3.

TABLE 3

| | | Viable cell counts (cells/g) | |
|---|---|---|---|
| | Initial cell counts | | Hypochlorous acid |
| Vegetable | (cells/g) | Radical water | aqueous solution |
| Welsh onion | 1.2 × 10⁵ | 5.6 × 10³ | 3.8 × 10³ |
| Cucumber | 6.1 × 10⁴ | 4.4 × 10² | 3.6 × 10² |
| Carrot | 1.4 × 10⁴ | 2.7 × 10¹ | 4.0 × 10¹ |
| Lettuce | 9.0 × 10⁴ | 1.0 × 10³ | 8.0 × 10² |
| Macrophyll | 1.4 × 10⁷ | 8.1 × 10³ | 3.8 × 10³ |
| Radish | 3.3 × 10³ | 9.0 × 10⁰ | 4.5 × 10⁰ |

From Table 3, it was confirmed that the radical water of the present invention exerted a washing ability substantially equal to that of a hypochlorous acid aqueous solution.

### Experimental Example 7

Using the apparatus shown in FIG. 2, ozone of an amount exceeding solubility was blown into tap water, and then irradiation of ultraviolet lamp was conducted to generate radical water at 3 L/minute. Then at the point of time when oxidation-reduction potential immediately after generation was 600-700 mV, bacteria removing effect was confirmed in a shower mode so that radical water was in contact with the object to be processed. A kitchen knife that was sterilized and used to cut fish for allowing adhesion of bacteria was brought into contact with the radical water in a shower mode, and viable cell counts after 5 seconds and 10 seconds were calculated by a wiping test method. Decreasing rate of oxidation-reduction potential of the radical water was 5 mV/second. As a comparative experiment, a similar knife was brought into contact with tap water, 70% ethanol aqueous solution and ozone water (3 ppm) in a shower mode, and viable cell counts after 5 seconds and 10 seconds were calculated by a wiping test method.

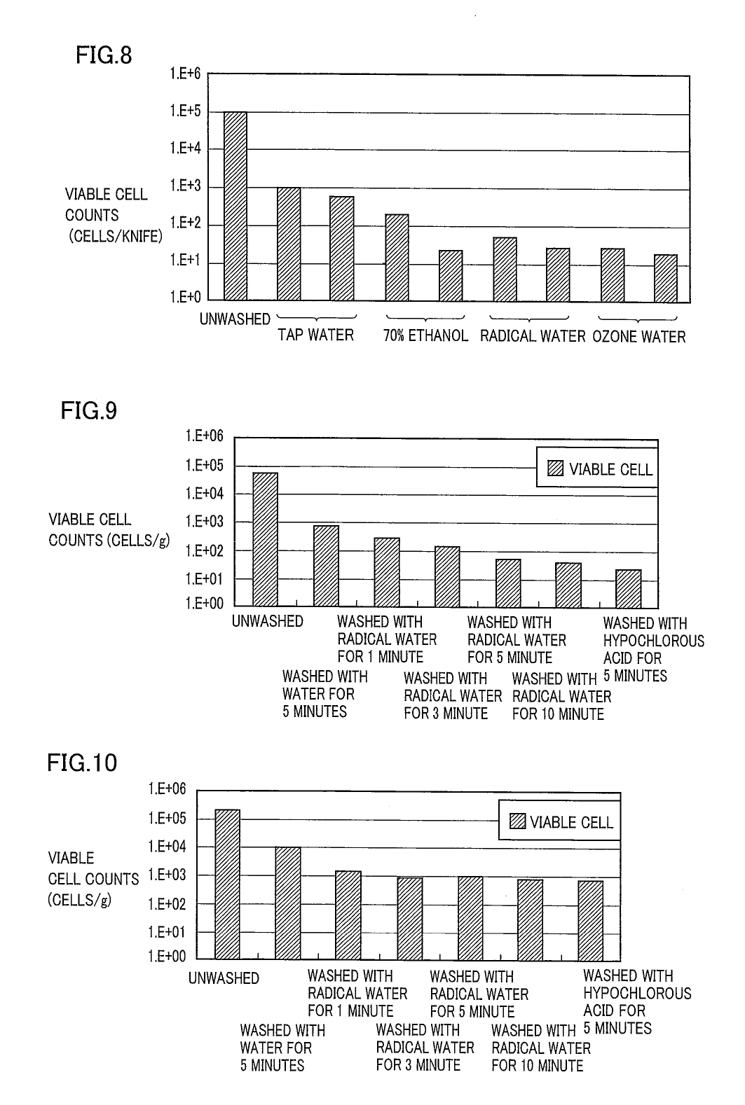

FIG. 8 is a graph showing a result of Experimental Example 7, and shows viable cell counts (cells/knife) for the respective cases including unwashed, tap water (after 5 seconds, after 10 seconds), 70% ethanol aqueous solution (after 5 seconds, after 10 seconds), radical water (after 5 seconds, after 10 seconds), and ozone water (after 5 seconds, after 10 seconds). From FIG. 8, it was confirmed that radical water had a bacterial removing ability substantially equal to that of 70% ethanol aqueous solution that is commonly used for bacterial removal of a knife.

### Experimental Example 8

An experiment for comparing the effect of removing bacteria when bacteria removing process was conducted in a dipping mode and in a shower mode using cabbage cut into strips from which leaching liquid exudes abundantly as an object to be processed was conducted. The process in a dipping mode was conducted using the apparatus shown in FIG. 2, by blowing ozone of an amount exceeding solubility into tap water, conducting irradiation of ultraviolet lamp to generate radical water at 3 L/minute, putting the radical water at the point of time when oxidation-reduction potential immediately after generation was 400 to 500 mV into a processing bath (5 L), and dipping about 25 g of cabbage cut into strips thereinto. The process in a shower mode was conducted by supplying the radical water generated in a similar manner into a shower head, and bringing shower-like radical water into contact with about 25 g of cabbage cut into strips put into the processing bath (5 L). For each of the dipping mode and the shower mode, viable cell counts after 1 minute, 3 minutes, 5 minutes and 10 minutes from the start of the process were calculated in a similar manner as in Experimental Example 4. Decreasing rate of oxidation-reduction potential of the radical water was 5 mV/second. As a comparative experiment, processes were conducted in a dipping mode and in a shower mode for 5 minutes using tap water, and 200 mg/L of a hypochlorous acid aqueous solution, and viable cell counts after these processes were also calculated.

FIG. 9 is a graph showing a result for a dipping mode in Experimental Example 8, and FIG. 10 is a graph showing a result for a shower mode in Experimental Example 8. In each of FIGS. 9 and 10, viable cell counts (cells/g) for an unwashed case, and for the cases after processes with tap water (5 minutes), radical water (1 minute, 3 minutes, 5 minutes and 10 minutes), and a hypochlorous acid aqueous solution (5 minutes) are shown. From FIGS. 9 and 10, it can be found out that as for the dipping mode, about 10 minutes were required to obtain a substantially equal effect as that obtained in a process for 5 minutes in a dipping mode using a hypochlorous acid aqueous solution, while as for the shower mode, about 3 minutes were required to obtain a substantially equal effect as that obtained in a process for 5 minutes in a shower mode using a hypochlorous acid aqueous solution.

### Experimental Example 9

An experiment of evaluating a washing effect was conducted using radical water at the point of time when oxidation-reduction potential immediately after generation was 400 to 500 mV by conducting irradiation of ultraviolet lamp after blowing ozone of an amount exceeding solubility into tap water using the apparatus shown in FIG. 2. As an object to be processed, the one produced by separately applying appropriate amounts of each of soiling substances (DiaPaste (Japan Chemical Fibers Association Standard, reagent for evaluating antifouling finish), soy sauce (dark soy sauce, product of Kikkoman Corporation), sauce (product of KYK), ketchup (product of KAGOME CO., LTD.), coffee (canned coffee, product of CALPIS Co., Ltd.) to a piece of thick 100% cotton cloth cut into about 20-cm square, and drying in air for 2 hours was used. Radical water was circulated between a processing bath (20 L) and a tank to stir the radical water in the processing bath, and one sheet of the above cotton cloth was dipped in the radical water for 20 minutes. Decreasing rate of oxidation-reduction potential of the radical water was 5 mV/second. As a comparative experiment, using the same apparatus, tap water, or tap water into which 10 g of detergent (Top, product of Lion Corporation) was added was also circulated between the processing bath and the tank, to execute a dipping process for 20 minutes. When detergent was used, rinsing process with flowing water was conducted for about 3 minutes after the dipping process.

For cotton cloths respectively obtained in the above processes, the condition of a soiling substance was visually observed, and the washing effect was evaluated. When washed with tap water, the stain of soy sauce was removed, however, other soiling substances remained. When washed with tap water added with detergent, soiling substances were totally removed, however, stains of the substances other than soy sauce still remained. When washed with tap water added with detergent, whiteness of the entire cloth was improved due to bleaching effect. On the other hand, when washed with radical water, in addition to stain of soy sauce, stains of sauce and ketchup that were not removed even by washing with tap water added with detergent were removed.

### Experimental Example 10

Using the apparatus shown in FIG. 2, ozone of an amount exceeding solubility was blown into tap water, and then irradiation of ultraviolet lamp was conducted to generate radical water at 3 L/minute. Then at the point of time when oxidation-reduction potential immediately after generation was 600 to 700 mV, particle removing effect was confirmed in a shower mode so that radical was in contact with an object to be processed. As the object to be processed, according to the description of Japanese Patent No. 2983438, a film obtained by applying an aromatic compound that causes ablation under ultraviolet laser light on a film made of PFA, and irradiating with excimer laser to make carbon particles adhere on the surface of the film was used. The aforementioned radical water was supplied to a shower head, and shower-like radical water was poured on an object to be processed put into a processing bath, and a process in a shower mode was conducted for about 10 minutes. Decreasing rate of oxidation-reduction potential of the radical water was 5 mV/second. As a comparative experiment, a process of pouring shower-like tap water in a similar manner on the object to be processed for about 10 minutes was conducted. The above experiment was conducted on five kinds of objects to be processed, and contact angle of the surface of each object to be processed after process was calculated by using an image processing type contact angle meter CA-X (manufactured by KYOWA INTERFACE SCIENCE CO., LTD.). The result is shown in Table 4.

TABLE 4

| | Unprocessed | Tap water | Radical water |
|---|---|---|---|
| Film 1 | 122.4 | 76 | 48.4 |
| Film 2 | 108.7 | 78.6 | 31.4 |
| Film 3 | 121.2 | 80.9 | 43.3 |
| Film 4 | 99.3 | 80.8 | 40.1 |
| Film 5 | 134.5 | 67.3 | 53.5 |
| Average | 117.2 | 76.7 | 43.4 |

From Table 4, it was confirmed that contact angle significantly decreased in radical water, compared to the case of tap water, and hence radical water had the particle removing effect. Superior washing ability of radical water to that of tap water was clearly observed even by visual check.

### Experimental Example 11

After preparing 20 ppm of carbon dioxide gas using tap water, ultrapure water as raw water using the apparatus shown in FIG. 2, ozone of an amount exceeding solubility was blown into tap water, and then irradiation of ultraviolet lamp was conducted to generate radical water at 3 L/minute. Then at the point of time when oxidation-reduction potential immediately after generation was 400 to 500 mV, the bacteria removing effect was confirmed in a dipping mode so that radical water was in contact with an object to be processed. As the object to be processed, macrophyll was used, and about 5 g of macrophyll was put into a 5 L processing bath accommodating radical water and allowed to dip therein for 5 minutes, to conduct a washing process. Decreasing rate of oxidation-reduction potential of the radical water was 5 mV/second. As a comparative experiment, a similar washing process was conducted using tap water. After process, bacteria were extracted from the macrophyll, and viable cell counts were respectively calculated by a pour plate method.

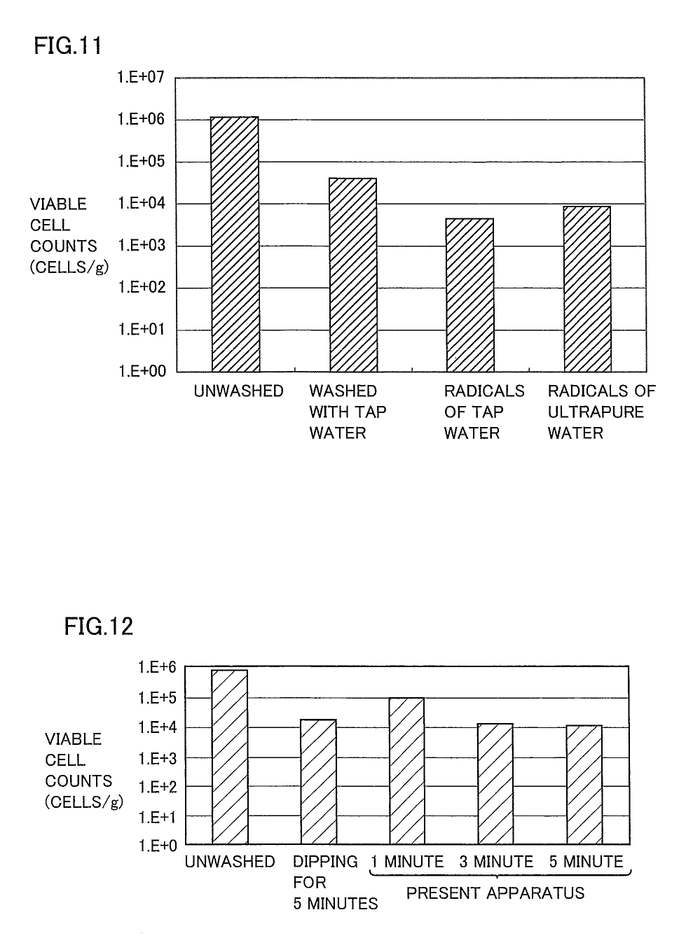

FIG. 11 is a graph showing a result of Experimental Example 11, and shows viable cell counts (cells/g) for the unwashed case, and after process with tap water, after process with radical water produced by using tap water, and after process with radical water produced by using ultrapure water. From FIG. 11, it can be found out that the radical water produced from ultrapure water as raw water showed slightly lower washing effect compared to the radical water produced from tap water as raw water, however, both of radical waters produced from tap water and from ultrapure water as raw water showed higher washing effect compared to a case where tap water was used.

### Experimental Example 12

Using the washing apparatus of the example shown in FIG. 3, a washing experiment of vegetable was conducted, and a washing effect was confirmed. 7.3 kg (about 18 L) of cucumber was put into a processing bath (56 L) of the apparatus, and radical water was supplied in a shower mode at 15 L/min while the water level in the bath was kept so that the vegetable was substantially dipped, and a washing process was conducted for 1 minute, 3 minutes and 5 minutes. After the washing process, a part of sample was collected, and viable cell counts (cells/g) adhered to the vegetable was calculated by a pour plate method.

For comparison, experiments were also conducted for a case where washing was not conducted, and for a case where washing in a dipping mode was conducted. In the dipping mode, since it is necessary to make a processing bath large from the view point of stirring, a 135 L processing bath was used, and radical water was injected into the bath at 15 L/min to overflow, and 7.3 kg (about 18 L) of cucumber was put therein, and stirring was conducted by bubbling from the bottom of the processing bath. In these cases, viable cell counts (cells/g) were also calculated in a similar manner.

The result is shown in FIG. 12. From FIG. 12, it was confirmed that 5 minutes are required to remove bacterial from cucumber in a dipping mode, while an equivalent washing effect was achieved in 3 minutes when the washing apparatus of the present invention shown in FIG. 3 was used. The washing apparatus of the present invention employing a shower mode requires no stirring, so that the processing bath can be made small and higher water-saving effect is realized compared with the dipping mode.

1. A method of washing an object to be processed using water containing at least either one selected from a hydrogen radical and a carbon radical.

2. The method according to claim 1, wherein the water containing at least either one selected from a hydrogen radical and a carbon radical exhibits decrease from 800 mV to 200 mV of oxidation-reduction potential at a decreasing rate of 100 mV/second or less.

3. The method according to claim 1, wherein the water containing at least either one selected from a hydrogen radical and a carbon radical is produced by causing generation of hydroxyl radical in water containing a water-soluble organic substance.

4. The method according to claim 1, wherein the water containing at least either one selected from a hydrogen radical and a carbon radical is produced by causing generation of hydroxyl radical in water mixed with gas containing at least either one selected from a hydrogen atom and a carbon atom.

5. The method according to claim 1, wherein said water containing at least either one selected from a hydrogen radical and a carbon radical is brought into contact with the object to be processed in a dipping mode or in a shower mode.

6. The method according to claim 5, wherein said water containing at least either one selected from a hydrogen radical and a carbon radical is brought into contact with the object to be processed in a shower mode.

7. The method according to claim 6, wherein the object to be processed is washed by supplying water containing at least either one selected from a hydrogen radical and a carbon radical in a shower mode from above a processing bath so that water containing at least either one selected from a hydrogen radical and a carbon radical is pooled in the processing bath in such an amount that the object to be processed can be dipped, in a condition that said water containing at least either one selected from a hydrogen radical and a carbon radical after process is discharged from bottom of the processing bath.

8. A washing apparatus comprising:
a processing bath for washing an object to be processed, and
a means for supplying said processing bath with water containing at least either one selected from a hydrogen radical and a carbon radical.

9. The apparatus according to claim 8, wherein said means for supplying water containing at least either one selected from a hydrogen radical and a carbon radical has a means for supplying water containing a water-soluble organic substance and a means for causing generation of a hydroxyl radical in the water containing a water-soluble organic substance.

10. The apparatus according to claim 8, wherein said means for supplying water containing at least either one selected from a hydrogen radical and a carbon radical has a means for mixing gas containing at least either one selected from a hydrogen atom and a carbon atom into water, and a means for causing generation of a hydroxyl radical in water mixed with the gas.

11. The apparatus according to claim 8, further comprising a shower head having a means for supplying water containing a water-soluble organic substance or water mixed with gas containing at least either one selected from a hydrogen atom and a carbon atom and generating said hydroxyl radical in the water, wherein water containing at least either one selected from a hydrogen radical and a carbon radical is supplied to the processing bath via the shower head in a shower mode.

12. The apparatus according to claim 8, further comprising a processing bath configured so as to discharge water containing at least either one selected from a hydrogen radical and a carbon radical after process in the bottom, and a means for supplying water containing at least either one selected from a hydrogen radical and a carbon radical in a shower mode via a shower head from above said processing bath, wherein said means for supplying water containing at least either one selected from a hydrogen radical and a carbon radical preferably has a configuration to supply water containing at least either one selected from a hydrogen radical and a carbon radical into the processing bath so that water containing at least either one selected from a hydrogen radical and a carbon radical is pooled in the processing bath in such an amount that an object to be processed can be dipped in a condition that the water containing at least either one selected from a hydrogen radical and a carbon radical after process is discharged from bottom of said processing bath.

13. The washing apparatus according to claim 12, wherein the processing bath is formed into mesh in its bottom only.

14. The washing apparatus according to claim 12, wherein said processing bath has a pump for discharging water containing at least either one selected from a hydrogen radical and a carbon radical after process in its bottom.

15. The washing apparatus according to claim 12, capable of keeping water level of water containing at least either one selected from a hydrogen radical and a carbon radical in said processing bath constant.

16. The washing apparatus according to claim 12, wherein the processing bath is able to oscillate.

17. The washing apparatus according to claim 12, wherein a means for supplying bubbling air is provided in the bottom of the processing bath.
